(19) United States
(12) Patent Application Publication
(10) Pub. No.: US 2024/0127241 A1
(43) Pub. Date: Apr. 18, 2024

(54) SYSTEM AND METHOD FOR ELECTRONIC RESOURCE TRANSFER AUTHENTICATION VIA A USER CHARACTERISTIC DATA VERIFICATION ENGINE

(71) Applicant: BANK OF AMERICA CORPORATION, Charlotte, NC (US)

(72) Inventors: Christopher Daniel Birch, Tega Cay, SC (US); Sophie Morgan Danielpour, Durham, NC (US); Susan R. Hart, Addison, TX (US); Son Huynh, Charlotte, NC (US); Tyler Keith Prothro, Waxahachie, TX (US); Shannon Sabina Rolinger, Pineville, NC (US); Amado Jose Martinez Suarez, Addison, TX (US); Stephen Jack Williams, Charlotte, NC (US)

(73) Assignee: BANK OF AMERICA CORPORATION, Charlotte, NC (US)

(21) Appl. No.: 17/964,254

(22) Filed: Oct. 12, 2022

(51) Int. Cl. G06Q 20/40; G06Q 20/38; G06Q 20/42

(52) U.S. Cl. CPC G06Q 20/4014; G06Q 20/3825; G06Q 20/42

(57) ABSTRACT

Systems, computer program products, and methods are described herein for electronic resource transfer authentication via a user characteristic data verification engine. The system receives a request to transfer electronic resources from a first endpoint device of a merchant. The system then identifies a resource vehicle owner associated with the electronic resource transfer, identifies at least one second endpoint device, then transmits a request for verification from the entity to the at least one second endpoint device, utilizing an application programming interface. The user characteristic feedback hardware of the at least one second endpoint device collects identifier data from the user of the at least one second endpoint device, and a user characteristic data verification engine is initiated and thereafter determines a binary identification output. An entirety of the electronic resources are distributed to the merchant based on the binary identification output.

### FIELD OF THE INVENTION

The present invention embraces a system for electronic resource transfer authentication via a user characteristic data verification engine.

### BACKGROUND

Currently, entities, merchants, and users associated with entities may occasionally experience malfeasance in the form of use of resource vehicles by users who obtain the resource vehicles in a nefarious manner. Such uses lead to temporary loss of access to a user's account with the entity, and ultimately a loss of electronic resources at the entity unless the nefarious user is held accountable. Numerous systems and methods exist for proactively deterring nefarious users from engaging in such activities, for example, the use of a falsely obtained resource vehicle may prompt the nefarious user at the endpoint device to enter a PIN number or ZIP code to theoretically verify the identity of the user of the resource vehicle. Other systems and methods may employ machine learning techniques to identify trends of use of a resource vehicle which raises suspicion to the entity. However, there may be scenarios where skilled nefarious users can successfully circumvent such existing systems and methods. As a result, the needs of the entity who provides services to the users and merchants are unmet and thus results in a loss of productivity, added expenses, unexpected delays, or the like. As such, there is a need for a system and method for electronic resource transfer authentication via a user characteristic data verification engine.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later. Embodiments of the invention are directed to a system, method, or computer program product for electronic resource transfer authentication via a user characteristic data verification engine, the invention may include receiving a request to transfer electronic resources from a first endpoint device of a merchant, wherein the request is transmitted from the first endpoint device to an entity, identifying a resource vehicle owner associated with the electronic resource transfer by comparing a resource vehicle identifier obtained by the first endpoint device with a plurality of resource vehicle identifiers in the at least one non-transitory storage device, the plurality of resource vehicle identifiers each associated with a corresponding user, identifying at least one second endpoint device, the at least one second endpoint device associated with the resource vehicle owner, transmitting a request for verification from the entity to the at least one second endpoint device, the request for verification utilizing an application programming interface of the at least one second endpoint device, activating user characteristic feedback hardware of the at least one second endpoint device to collect identifier data from a user of the at least one second endpoint device, receiving identifier data from the user of the at least one second endpoint device, initiating a user characteristic data verification engine, wherein the user characteristic data verification engine receives the identifier data and determines a binary identification output, and distributing an entirety of the electronic resources, based on the binary identification output, from an account associated with the resource vehicle owner to an account associated with the merchant.

In some embodiments, the user characteristic data verification engine may be configured to generate a unique signature object from the identifier data, wherein the unique signature object is configured to expire when an expiration condition is met and compare the unique signature object to a stored signature object.

In some embodiments, the user characteristic data verification engine may be further configured to continuously collect interaction data associated with the at least one second endpoint device and integrate the interaction data into the stored signature object.

In some embodiments, the user characteristic data verification engine may be further configured to determine the binary identification output, wherein the binary identification output is a first value when the unique signature object is not within an acceptability range of the stored signature object, and wherein the binary identification output is a second value when the unique signature object is within the acceptability range of the stored signature object.

In some embodiments, the expiration condition may be at least one selected from a group consisting of a predetermined time interval and a signature object mismatch.

In some embodiments, if the unique signature object expires, the user characteristic feedback hardware of the at least one second endpoint device may be configured to repeat the receiving of the identifier data from the user of the at least one second endpoint device.

In some embodiments, the stored signature object may be stored in a non-transitory storage device of the at least one second endpoint device.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for electronic resource transfer authentication via a user characteristic data verification engine, in accordance with an embodiment of the invention;

FIG. 2 illustrates a process flow for electronic resource transfer authentication via a user characteristic data verification engine, in accordance with an embodiment of the invention;

FIG. 3 illustrates a process flow for electronic resource transfer authentication via a user characteristic data verification engine, in accordance with an embodiment of the invention; and

FIG. 4 illustrates a process flow for a user characteristic data verification engine, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data, such as electronic resource transfer or communication data. Typically, these data can be related to the customers of the entity, its products or services, the people who work for the organization, or any other aspect of the operations of the organization, such as communicative interactions between customers and people who work for the organization. As such, the entity may be any institution, group, association, financial institution, establishment, company, union, authority or the like, employing information technology resources for processing large amounts of data.

As described herein, a “user” may be an individual associated with an entity, or it may be a customer with a transactional relationship with the entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “user characteristic data” may be any information that can be used to identify of a user based on the physical appearance, or physical characteristics of the user. For example, iris recognition, retina scans, fingerprints, finger veins, palm veins, palm prints, digital bone anatomy/structure and positioning (distal phalanges, intermediate phalanges, proximal phalanges, and the like), a unique intrinsic user activity, such as making a predefined motion with a user device. This user characteristic data may be used to authenticate the identity of the user (e.g., determine that the user characteristic data is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, user characteristic data may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, an “electronic resource” may generally refer to the data, data packet, tokens, or other digital representations of objects, products, devices, goods, commodities, services, and the like, and/or the ability and opportunity to access and use the same. The electronic resource may be represented on one or more ledgers of the entity or a merchant associated with the entity. Some example implementations herein contemplate property held by a user or a third-party entity such as a merchant. In some example implementations, an electronic resource may be associated with one or more accounts or may be property that is not associated with a specific account. Examples of electronic resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, an electronic resource is typically stored in a resource repository—a storage location where one or more resources are organized, stored and retrieved electronically using a computing device.

As used herein, a “electronic resource transfer,” “electronic resource distribution,” or “electronic resource allocation” may refer to any transaction, activities or communication between one or more entities (including, but not limited to, a merchant, a financial institution, a third-party entity, or the like), between the user and the one or more entities, or between the user and another user. An electronic resource transfer may refer to any distribution of electronic resources such as, but not limited to, a payment, processing of funds, purchase of goods or services, a return of goods or services, a payment transaction, a credit transaction, or other interactions involving a user's electronic resource or account. Unless specifically limited by the context, an “electronic resource transfer” a “transaction”, “transaction event” or “point of transaction event” may refer to any activity between a user, a merchant, an entity, or any combination thereof. In some embodiments, an electronic resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that electronic resource transfers or transactions are evaluated it could mean that the transaction has already occurred, is in the process of occurring or being processed, or it has yet to be processed/posted by one or more financial institutions.

As used herein, “resource vehicle” may refer to an electronic payment vehicle, or payment instrument, such as a credit or debit card, or electronic representations thereof, configured to initiate electronic resource transfers. As such, the resource vehicle may not be a physical “card” at all and may instead be account identifying information stored electronically in a user device, such as a digital wallet, tokens/aliases associated with a digital wallet, or account identifiers stored by a mobile application. Moreover, a “resource vehicle owner” may be a user associated with the entity who is the rightful owner of the resource vehicle. Accordingly, and as will be described in great detail herein, the purpose of the disclosed invention is to verify that a user at an endpoint device is in fact the resource vehicle owner, and therefore verify that the user at the endpoint device is not a user who is unauthorized to use the resource vehicle.

As used herein, an “endpoint device” may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

Prior to the invention described herein, entities did not have a system and method for authenticating electronic resource transfers with user characteristic data verification engines, and primarily relied on authentication methods such as PIN number entry, ZIP code entry, voice authentication via a telephone call with the owner of the account, and so forth. As noted, such authentication measures may offer a satisfactory level of verification of the user who is initiating an electronic resource transfer, such authentication measures can also be easily defeated by nefarious users who obtain possession of a resource vehicle

The invention disclosed herein provides a novel approach to implementing user characteristic information to authenticate an electronic resource transfer. The system and method to accomplish such authentication is primarily centered around the entity itself, such that the same entity that controls aspects of the electronic resource transfer is able to likewise control aspects regarding the user characteristic authentication of the electronic resource transfer. In this way, the electronic resource transfer may be interrupted or terminated, or otherwise validated in an alternate way prior to the electronic resource transfer being completed. The purpose of the disclosed invention is to verify that a user at an endpoint device is in fact the resource vehicle owner, and therefore verify that the user at the endpoint device is not a user who is unauthorized to use the resource vehicle.

Accordingly, the present invention receives a request to transfer electronic resources from an endpoint device of a merchant. The user associated with the electronic resource transfer is determined based on the account of the user, determined from the resource vehicle. Next, the endpoint devices associated with the user are determined, and an application programming interface is engaged with on the endpoint devices. The application programming interface is maintained by or integrated with the entity, such as an application. User characteristic hardware then collects the user characteristic data from the user, and a user characteristic data verification engine then generates a unique signature object from this user characteristic data. The unique signature object is then compared with stored objects which have been previously saved. The stored signature object may be configured to receive or be combined with the unique signature object, in order to have a more flexible stored signature object. If the unique signature object is compared with the stored signature object and it is not within an acceptability range, the electronic resource transfer is declined. However, if the unique signature object is compared with the stored signature object and it is within the acceptability range, an entirety of the electronic resources is distributed to the merchant based on the binary identification output.

What is more, the present invention provides a technical solution to a technical problem. As described herein, the technical problem includes the current primary reliance on user characteristics or keypad entries to authenticate electronic resource transfers at an endpoint level, by validating digital wallet electronic resource transfers through local hardware with no communication with the entity. Thus, electronic resource transfers using resource vehicles are not offered the same benefits of user characteristic security. Moreover, the user characteristic authentication currently in use has no integration with the entity, thus the entity has no control or authority over attempted electronic resource transfers. The technical solution presented herein allows for user characteristic data to be utilized at endpoint devices which are integrated with and operatively coupled with an entity. By doing so, the entity is able to conduct authentication independently, based on the user characteristic data, and intervene in the electronic resource transfer if the user characteristic data is not matched with the user associated with the account. In particular, the system is an improvement over existing electronic resource transfer authentication solutions by authenticating electronic resource transfers (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing and manual resources.

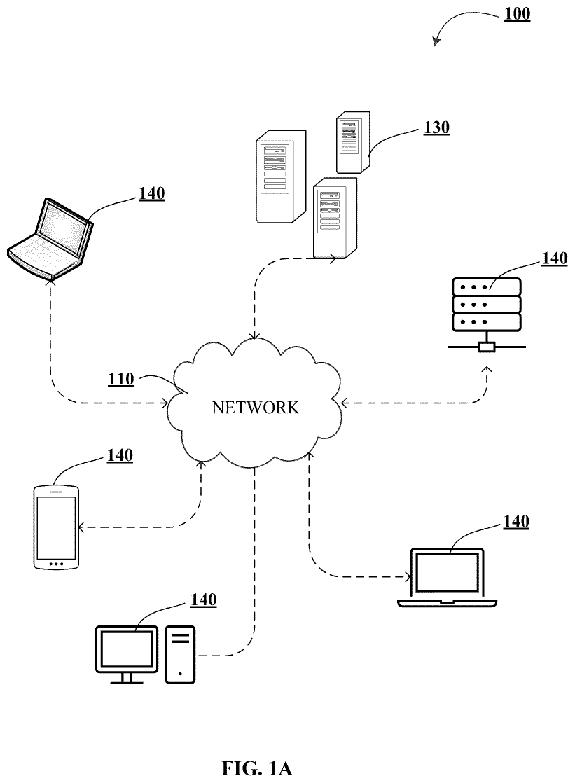

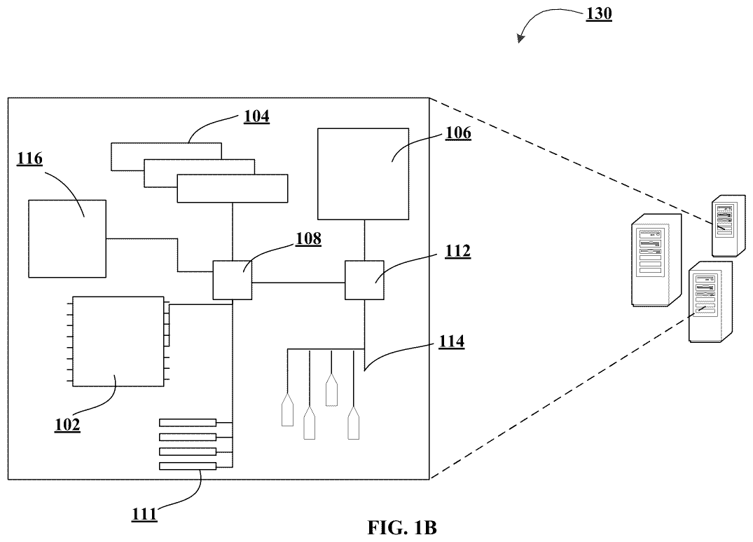

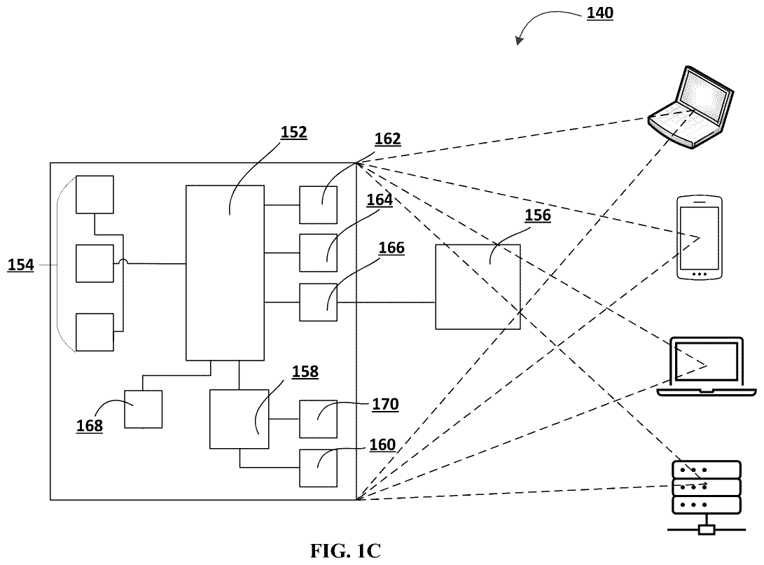

FIGS. 1A-1C illustrate technical components of an exemplary distributed computing environment for electronic resource transfer authentication via a user characteristic data verification engine 100, in accordance with an embodiment of the invention. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the endpoint device(s) 140 may have a client-server relationship in which the endpoint device(s) 140 are remote devices that request and receive service from a centralized server, i.e., the system 130. In some other embodiments, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The endpoint device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with an embodiment of the invention. As shown in FIG. 1C, the endpoint device(s) 140 includes a processor 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the endpoint device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the endpoint device(s) 140, such as control of user interfaces, applications run by endpoint device(s) 140, and wireless communication by endpoint device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a SIMM (Single In Line Memory Module) card interface. Such expansion memory may provide extra storage space for endpoint device(s) 140 or may also store applications or other information therein. In some embodiments, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to endpoint device(s) 140, which may be used as appropriate by applications running thereon, and in some embodiments, one or more applications operating on the system 130.

The endpoint device(s) 140 may also communicate audibly using audio codec 162, which may receive spoken information from a user and convert it to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some embodiments, one or more applications operating on the system 130.

Various implementations of the distributed computing environment 100, including the system 130 and endpoint device(s) 140, and techniques described here can be realized in digital electronic circuitry, integrated circuitry, specially designed ASICs (application specific integrated circuits), computer hardware, firmware, software, and/or combinations thereof.

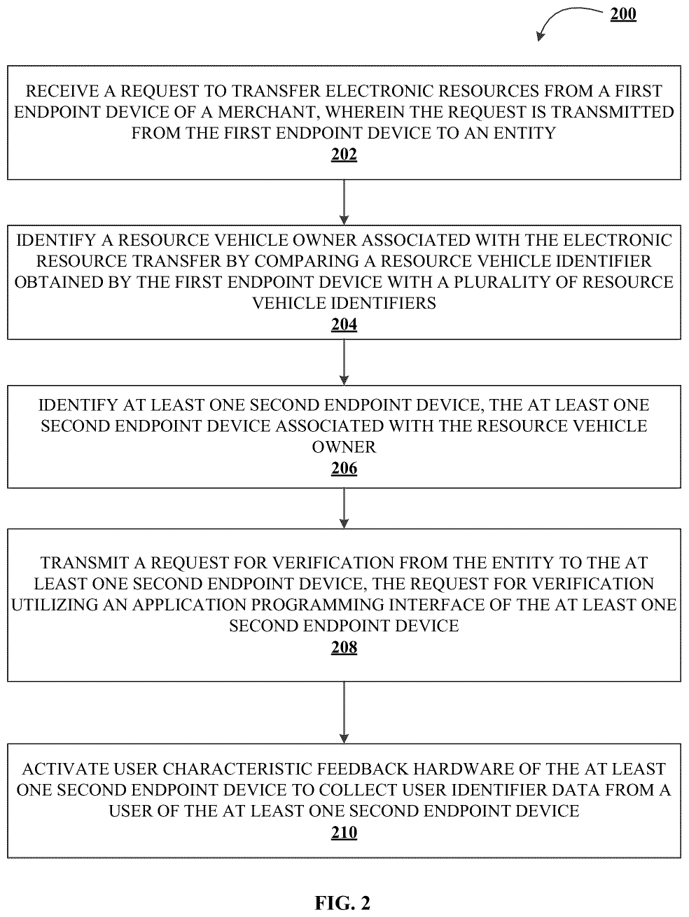

FIG. 2 illustrates a process flow 200 for electronic resource transfer authentication via a user characteristic data verification engine, in accordance with an embodiment of the invention. The process begins at block 202, where the system receives a request to transfer electronic resources from a first endpoint device of a merchant. As shall be appreciated, an endpoint device may be a POS terminal at a merchant, or it may be an ATM, or numerous other embodiments as previously described. A user may approach the endpoint device with the intent to trade electronic resources for goods, services, cash, or the like offered at the endpoint device by the merchant. Accordingly, the merchant or the user will engage with the endpoint device, such as to enter a currency amount, in order to initiate the transfer of electronic resources pursuant to this exchange. Thereafter, or in some embodiments beforehand, the user will engage with the endpoint device to present the endpoint device with a resource vehicle by swiping the resource vehicle, using near-field communication (NFC) (e.g., “tapping” the resource vehicle), or inserting the resource vehicle into a receptacle of the endpoint device for reading a “chip” of the resource vehicle.

After the resource vehicle, or information on the resource vehicle, has been entered into the endpoint device, it shall be appreciated by one of ordinary skill in the art that the endpoint device is configured to determine which entity is associated with the resource vehicle. For example, a resource vehicle may comprise an identifier such as a series of numbers, such that a particular sequence of numbers is associated with a certain entity. In this way, when the endpoint device reads the sequence of numbers and recognizes, as one non-limiting example, that a sequence of “1234” is associated with “Entity A”, and a sequence of “7890” is associated with “Entity B”, and so forth. Entities determined by the endpoint device may have a unique IP address or communication portal to which the entity receives data associated with each electronic resource transfer, such as to update corresponding ledgers of users, etc. Accordingly, the request to transfer electronic resources when the user or merchant interacts with the endpoint device may be transmitted from the endpoint device to the entity. The request to transfer electronic resources may be received and evaluated (as described in further detail herein) by the entity prior to approving or declining the request, such as to prevent malfeasance from occurring by unauthorized use of the resource vehicle.

In block 202 the system identifies a resource vehicle owner associated with the electronic resource transfer by comparing a resource vehicle identifier obtained by the endpoint device with a plurality of resource vehicle identifiers in the at least one non-transitory storage device, the plurality of resource vehicle identifiers each associated with a corresponding user. At this point in the process, the entity has received communication from the endpoint device that a user is engaging in a transfer of electronic resources. The entity, being associated with the user, has records and data involving the user and the resource vehicles associated with the user. In this way, when a request to transfer electronic resources is received by the entity, the entity receives the resource vehicle identifier (e.g., the series of numbers of the resource vehicle) and is thereafter able to search the records of the entity to determine the resource vehicle owner by matching the identifier with a database of records at the entity. When the entity system parses the database for the resource vehicle identifier, the entity will know the resource vehicle owner when the resource vehicle identifier is identical to that which is in the database.

In some embodiments, and additional step of encryption and/or decryption of the resource vehicle identifier may occur prior to or after the transmission of the resource vehicle identifier to the entity from the endpoint device, such as to obscure the resource vehicle identifier from nefarious actors who may inadvertently receive the resource vehicle identifier. In some embodiments, only a portion of the resource vehicle identifier is transmitted to the entity, such as the first four digits, the last four digits, the first 8 digits, the last 8 digits, and so forth. In this way, any number of digits may be used to determine the resource vehicle owner.

As illustrated in block 204, the system then identifies at least one second endpoint device, the at least one second endpoint device associated with the resource vehicle owner. The entity, along with a database linking users to the various resource vehicles owned by the users, also may maintain a database linking these same users (e.g., the resource vehicle owners) to certain endpoint devices. As one non-limiting example, a resource vehicle owner may have a mobile phone, a computer, and a tablet device. Some resource vehicle owners may only use one endpoint device. Each of these devices may have previously undergone registration with the entity, for example by downloading and logging into an application or program. In this way, the entity receives endpoint device data regarding the phone number, and/or IP address of the device, and/or Media Access Control (“MAC”) address of the device, and/or mobile identification number (“MIN”), and/or international mobile subscriber identity (“IMSI”), and/or unique device identifier (“UDID”), and/or international mobile equipment identity (“IMEI”). This endpoint device data may be stored in the database along with the various users who are associated with these endpoint devices, which may be determined based on the last known user to log-in to entity systems from the endpoint device. The system may be configured to purge endpoint devices from the database that have not been utilized by users in a predetermined amount of time, such as within the past 30 days, 60 days, and so forth. In this way, only the most relevant endpoint devices are maintained in the database.

In block 208, the system transmits a request for verification from the entity to the at least one second endpoint device, the request for verification utilizing an application programming interface of the at least one second endpoint device. The endpoint device(s) associated with the resource vehicle owner will be configured with an application programming interface (“API”) which is structured to receive push communications (such as notifications) from the entity. If the endpoint device has the application or API installed and push communications are enabled, commands can be sent by the entity at any time. Push communications can be sent without the application requiring the user's contact information.

Accordingly, as illustrated in block 210, in some embodiments the push communication may activate user characteristic feedback hardware of the at least one second endpoint device to collect identifier data from a user of the at least one second endpoint device. Endpoint devices may be configured with any number of user characteristic feedback hardware, such as cameras, fingerprint scanners, retinal scanner, LIDAR devices, and so forth. When the endpoint device receives the push communication, it may prompt the user to engage with the endpoint device via a text pop-up notification, SMS message, phone call, or the like. Upon the user's interaction with the user device, such as bypassing a lock screen or screen saver, subsequently the endpoint device activates (e.g., turns on) the user characteristic feedback hardware.

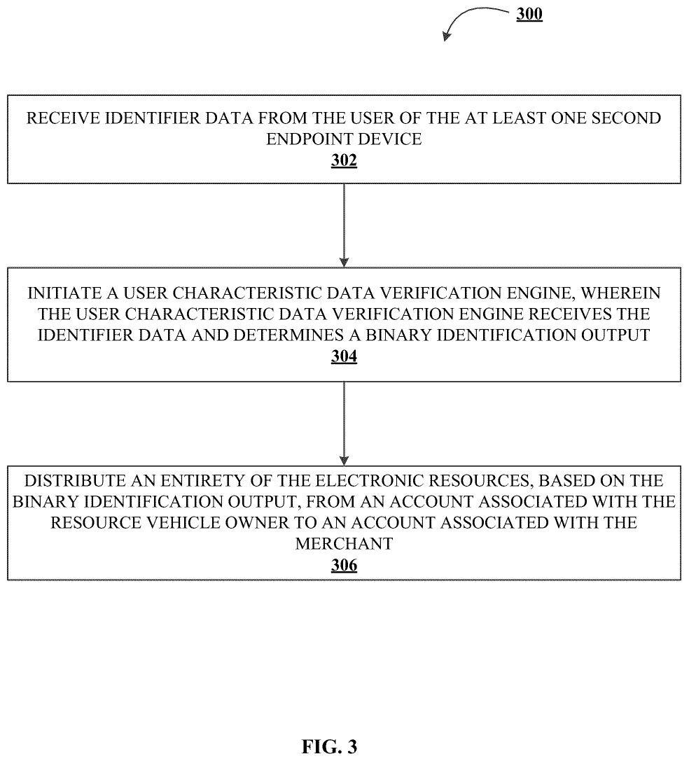

FIG. 3 illustrates a process flow 300 for electronic resource transfer authentication via a user characteristic data verification engine, in accordance with an embodiment of the invention. As shown in block 302, the system receives identifier data from the user. In other words, a user's physical characteristics such as face shape, retinal shape, retinal colors and/or patterns, distance between retinas, fingerprint lines, palm print lines, or the like are converted from a physical shape to computer data (e.g., identifier data) using the user characteristic feedback hardware in conjunction with accompanying software to compile and/or arrange the identifier data. For example, in some embodiments when a fingerprint, palm, or retina reader, scanner, or similar device is used as the user characteristic feedback hardware, the user characteristic feedback hardware may include an optical scanner which projects a light from a light source (which may be visible light, infrared, ultraviolet, etc.) onto a surface of a user's body while a microchip in an image sensor of the optical scanner may sample various wavelengths of light to determine a depth of the surface of the user's body or location of features such as capillaries and vessels. The various depths or features may each be assigned binary, hexadecimal, or other values in order to convert the physical surface into a digitally replicated image stored as data.

In some embodiments, a capacitive scanner may be implemented as the user characteristic feedback hardware. Accordingly, the capacitive fingerprint scanner may use capacitor array circuits to track the detail of a surface of a user's body, such as a fingerprint or palm print. The surface ridges along a surface of a user's body may be placed over one or more conductive plates which changes the electrical energy stored in various capacitors, while air gaps between the surface ridges leave the electrical energy on the various capacitors unchanged. An operational amplifier integrator circuit may track these changes which may then be recorded by an analog-to-digital converter, where this data can be analyzed.

In additional embodiments, a camera may be implemented to determine the depths of various features of a body part of a user, such as a user's face. The camera may be configured to emit light (such as infrared, ultraviolet, or visible light) toward a user and project a plurality of dots onto the surface of a body part of a user. A collector may be implemented to receive wavelength data from the projection of the plurality of dots to determine a distance from the emitter, these distances and positions of the plurality of dots configured to be mapped into a mathematical model of a body part.

It shall be appreciated that the aforementioned examples of user characteristic feedback hardware are non-limiting examples, and accordingly it shall be appreciated that numerous other types of user characteristic feedback hardware exist and may be implemented in a similar way to receive identifier data from the user of the at least one second endpoint device through the endpoint device.

In some embodiments, the system receives the identifier data through transmission of the data from the endpoint device to the entity through the API which is operatively coupled to processing device(s) and/or memory device of the one or more the entity systems (e.g., at a location remote and communicatively coupled to the endpoint device). In other embodiments, the endpoint device itself may be structured to receive the identifier data and maintain the identifier data within a memory device of the endpoint device, for further processing by the processing device of the endpoint device.

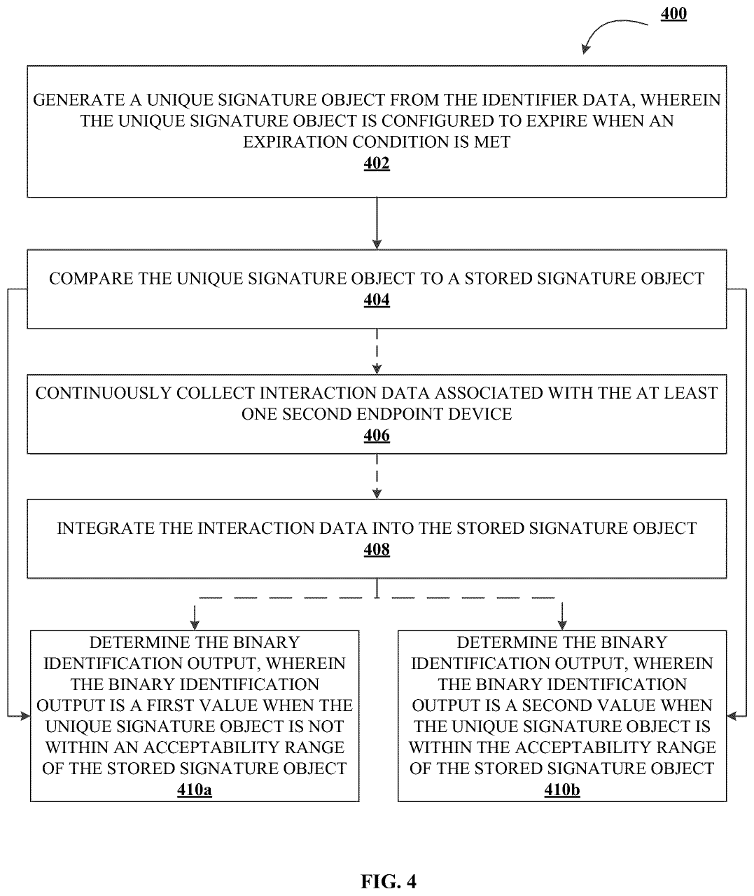

As illustrated in block 304, the system initiates a user characteristic data verification engine, wherein the user characteristic data verification engine receives the identifier data and determines a binary identification output. While some functionalities of the user characteristic data verification engine are described with respect to block 304, further functionalities and features will be described fully with respect to FIG. 4. After receiving the identifier data, the system must determine, by using the user characteristic data verification engine, whether the identifier data matches the identifier data associated with the resource vehicle owner. In some embodiments, it may be assumed that the identifier data collected at the endpoint device is the identifier data of the resource vehicle owner, in other words such that the identifier data is compared to historic, or recorded identifier data (“stored signature object”) of the user(s) of the endpoint device itself. In other embodiments, the identifier data may be compared to the stored signature object expected of the resource vehicle owner, such that it is endpoint device agnostic. The difference between the two embodiments may be such that the historic, or recorded resource vehicle owner stored signature objects may be stored remotely, e.g., separately from the user device, while the identifier data of the endpoint device may be stored remotely or locally, e.g., at the user device. Various aspects of the unique signature object(s) will be discussed and described fully with respect to FIG. 4.

Regardless, the user characteristic data verification engine is configured to compare the stored signature object to the identifier data (e. and output a binary identification output. In this way, the binary identification output provides the system with a “go” or “no-go” directive for completing the electronic resource transfer, based on the comparison of the identifier data to the unique signature object. Accordingly, if there is not a match or close relationship (as will be detailed herein) between the stored signature object and the identifier data, the system will output one binary output to halt the electronic resource transfer. If there is a match or close relationship between the stored signature object and the identifier data, the system will output a different binary output to proceed with the electronic resource transfer. The binary identification output could be selected from “1” and “0”, “yes” and “no”, or any combination of two non-identical identifiers.

As illustrated in block 306, distribute an entirety of the electronic resources, based on the binary identification output, from an account associated with the resource vehicle owner to an account associated with the merchant. Using the binary identification output provided in block 304, the system, if there is a match or close relationship between the stored signature object and the identifier data, will output a particular binary output to proceed with the electronic resource transfer. Accordingly, the entity will distribute all of the electronic resources from the account associated with the user to the merchant via an account associated with the merchant. In some embodiments, the system may simply mark the electronic resource as distributed for reimbursement to the account associated with the merchant at a later time, such as to place the electronic resources in a third account (e.g., in “escrow”).

FIG. 4 illustrates a process flow 400 for a user characteristic data verification engine, in accordance with an embodiment of the invention. As previously described with respect to FIG. 3, the user characteristic data verification engine will determine a binary identification output. As shown in block 402, to determine this binary identification output, the system will generate (e.g., compile) a unique signature object from the identifier data. It shall be appreciated that identifier data, when collected, may require further optimization in terms of the structure of the data, the filetype of the data, compression to reduce size of the data, and in this way a unique signature object may be formed from the identifier data. In some embodiments, the sensitivity of the underlying identifier data may encourage the encryption/decryption of the data during the formation of the unique signature object, such that anyone who obtains access to the unique signature object would be required to decrypt such unique signature object to use the identifier data. In some embodiments, none of the aforementioned manipulation is required. However, henceforth the identifier data and/or underlying identifier data shall be referred to as the unique signature object.

Under some operations circumstances, security is enhanced by adding a time limit to the unique signature object. In other words, to avoid this unique signature object being stored in one location for too long, the system may apply a time limit after which the unique signature object is no longer usable (e.g. a predetermined time interval). Further, the unique signature object may expire after the cancellation of an electronic resource transfer from one or more of the endpoint devices. What's more, the unique signature object may be configured to expire under circumstances where the unique signature object and the stored signature object are not within an acceptability range of each other (e.g., a signature object mismatch). After expiration, the unique signature object is deleted from the endpoint device(s) and/or the system. In this way, the unique signature object is configured to expire when an expiration condition is met.

If the unique signature object expires due to any of the aforementioned expiration conditions, the user characteristic feedback hardware of the at least one second endpoint device may be configured to repeat the receiving of the identifier data from the user of the at least one second endpoint device. In other words, the expiration condition may have been inadvertently reached, and accordingly the user may be provided at least one additional opportunity for the user characteristic feedback hardware to capture or receive the corresponding user characteristic information from the user.

As shown in block 404, the system then compares the unique signature object to a stored signature object. The stored signature object may be a compilation of a plurality of unique signature objects, each of the unique signature objects comprising the stored signature object. Accordingly, each of the unique signature objects provide identifier data, which when compared to other identifier data within the stored signature object provides a range of features (such as positions of valleys within a fingerprint, position of facial features, retinas, features of the retina, etc.). As previously described with respect to block 302, identifier data can be to pinpoint exact locations and physical dimensions of such features. By having a range of features (e.g., an array of user characteristic data confirmed to belong to the resource vehicle owner), the user characteristic input provided by a user at the endpoint device may be compared to the stored signature object to determine if the features of the user characteristic input falls within the range of values within the stored signature object.

As one non-limiting example, the position of the portion of a nasal region of a user may be collected by the user characteristic feedback hardware, determined by the distance between the nearest section of the nasal region (e.g., the tip of the nose) to that of the centroid of a left eye and centroid of a right eye. Accordingly, these distances, d1 (distance from tip of nose to left eye) and d2 (distance from tip of nose to right eye), may be compared to the range of acceptable distances r1 to r2 (for the distance to the left eye) and r3 to r4 (for the distance to the right eye) stored in the stored signature object. If d1 has a numerical value greater than r1 and less than r2, and d2 has a numerical value greater than r2 and less than r4, the system may determine the binary identification output to be a certain value to indicate that the unique signature object is within an acceptable range of the stored signature object, as shown in block 410b.

Conversely, if d1 has a numerical value less than r1 or greater than r2, and/or d2 has a numerical value less than r2 and greater than r4, the system may determine the binary identification output to be a different value to indicate that the unique signature object is not within the acceptable range of the stored signature object, as shown in block 410a. It shall be appreciated that in some embodiments, the acceptability range may also have allowances for error. Accordingly, d1 and d2 may be provided a buffer of up to 10%, such that even if d1 is 10% less than r1 or 10% greater than r2, and/or d2 is 10% less than r3 or 10% more than r4, the unique signature object is still considered to be within the acceptability range, thus proceeding to block 410b instead.

It shall be understood that the same technique may be applied to the other user characteristic measurements previously described, such as to compare locations and sizes of various portions of fingerprints, handprints, retinas, or the like. It shall also be appreciated that in order to normalize various measurements, reference measurements may be required. For example, continuing with the distance measurements between nose tip and eye centroid above, the distance between the left and right eye may first need to be measured, then reduced by a percentage (e.g., scaled) in order to match the distance between the left and right eye of the stored signature object. This percentage would then be applied to reduce or enlarge the distance measurements between nose tip and each eye centroid by the same scale. Thereafter, these scaled distance measurements between nose tip and each eye centroid would then be compared to r1, r2, r3, and r4 of the stored signature object and the binary identification output determined accordingly. In this way, the distance of a user from the user characteristic feedback hardware is of less concern.

In some embodiments stored signature object is stored in a non-transitory storage device of the at least one second endpoint device. In other words, the user characteristic data verification engine operates entirely on a second endpoint device, and communication with the entity systems is not required to determine the binary identification output. In other embodiments, the stored signature object is stored in a storage device of the entity (e.g., the entity systems located remotely from the at least one second endpoint device), and as such the user characteristic data verification engine is configured to be operatively coupled to the storage device of the entity for determination of the binary identification output. In this way, the storage of the stored signature object is in a centralized location. In other embodiments, the stored signature object and the user characteristic data verification engine are both located remotely from the at least one second endpoint device, such that the processing device and the storage device are in a centralized location remote from the second endpoint device and the system does not provide or communicate the binary identification output through communication to the second endpoint device at all. In other words, the second endpoint devices merely captures the unique identifier object and sends it to the processing device and the storage device of the entity.

In some embodiments, and as illustrated in block 406, the system may be configured continuously collect interaction data associated with the at least one second endpoint device. The interaction data comprises a plurality of unique signature objects. As previously described, measurements may be provided a buffer of up to 10%, such that even if a measurement is outside of the acceptability range by 10%, the unique signature object is still considered to be within the acceptability range. This can account for any variations or continuous in physical characteristics of a person, such as changes in facial hair, cosmetic surgery, aging, wrinkles, and the like. In order to document these changes and continue to evolve the stored signature object to better meet the needs of the user, the system collects (e.g., stores) these unique signature object and ultimately integrates this interaction data into the stored signature object. In this way, the parameters set forth in the stored signature object are dynamic and will lead to less false rejections of electronic resource transfers. The stored signature object will still maintain its current data, but the interaction data will be added thereto in a proportion equal to that of the 1:the number of unique signature objects that currently comprise the stored signature object. For example, if the stored signature object is comprised of 99 unique signature objects, a newly collected unique signature object which falls into the 10% margin of error (or “buffer”) will comprise 1/100th of the newly formed storage signature object.

The interaction data may also comprise a value known as a malfeasance object, the malfeasance object representing the number of declined electronic resource transfers, such as to indicate that an account or resource vehicle owner is unusually subject to malfeasance. The malfeasance object which is a 9 or 10 on a scale of 1 to 10 may indicate to the user characteristic data verification engine that the 10% buffer as previously described is too lenient, and therefore the user characteristic data verification engine should only provide a binary identification output to indicate that the unique signature object is within the acceptability range when it is exactly within said acceptability range. In other words, the 10% buffer is eliminated. Likewise, a malfeasance object which is a 1 or 2 on a scale of 1 to 10 may allow for the 10% buffer to remain intact, or in some embodiments increased to 15% or 20%.

As will be appreciated by one of ordinary skill in the art, the present invention may be embodied as an apparatus (including, for example, a system, a machine, a device, a computer program product, and/or the like), as a method (including, for example, a process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for electronic resource transfer authentication via a user characteristic data verification engine, the system comprising:
at least one non-transitory storage device; and
at least one processor coupled to the at least one non-transitory storage device, wherein the at least one processor is configured to:
receive a request to transfer electronic resources from a first endpoint device of a merchant, wherein the request is transmitted from the first endpoint device to an entity;
identify a resource vehicle owner associated with the electronic resource transfer by comparing a resource vehicle identifier obtained by the first endpoint device with a plurality of resource vehicle identifiers in the at least one non-transitory storage device, the plurality of resource vehicle identifiers each associated with a corresponding user;
identify at least one second endpoint device, the at least one second endpoint device associated with the resource vehicle owner;
transmit a request for verification from the entity to the at least one second endpoint device, the request for verification utilizing an application programming interface of the at least one second endpoint device;
activate user characteristic feedback hardware of the at least one second endpoint device to collect identifier data from a user of the at least one second endpoint device;
receive identifier data from the user of the at least one second endpoint device;
initiate a user characteristic data verification engine, wherein the user characteristic data verification engine receives the identifier data and determines a binary identification output; and
distribute an entirety of the electronic resources, based on the binary identification output, from an account associated with the resource vehicle owner to an account associated with the merchant.

2. The system of claim 1, wherein the user characteristic data verification engine is configured to:
generate a unique signature object from the identifier data, wherein the unique signature object is configured to expire when an expiration condition is met; and
compare the unique signature object to a stored signature object.

3. The system of claim 2, wherein the user characteristic data verification engine is further configured to:
continuously collect interaction data associated with the at least one second endpoint device; and
integrate the interaction data into the stored signature object.

4. The system of claim 2, wherein the user characteristic data verification engine is further configured to determine the binary identification output, wherein the binary identification output is a first value when the unique signature object is not within an acceptability range of the stored signature object, and wherein the binary identification output is a second value when the unique signature object is within the acceptability range of the stored signature object.

5. The system of claim 2, wherein the expiration condition is at least one selected from a group consisting of: a predetermined time interval and a signature object mismatch.

6. The system of claim 2, wherein if the unique signature object expires, the user characteristic feedback hardware of the at least one second endpoint device is configured to repeat the receiving of the identifier data from the user of the at least one second endpoint device.

7. The system of claim 2, wherein the stored signature object is stored in a non-transitory storage device of the at least one second endpoint device.

8. A computer program product for electronic resource transfer authentication via a user characteristic data verification engine, the computer program product comprising a non-transitory computer-readable medium comprising code causing an apparatus to:
receive a request to transfer electronic resources from a first endpoint device of a merchant, wherein the request is transmitted from the first endpoint device to an entity;
identify a resource vehicle owner associated with the electronic resource transfer by comparing a resource vehicle identifier obtained by the first endpoint device with a plurality of resource vehicle identifiers in the at least one non-transitory storage device, the plurality of resource vehicle identifiers each associated with a corresponding user;
identify at least one second endpoint device, the at least one second endpoint device associated with the resource vehicle owner;
transmit a request for verification from the entity to the at least one second endpoint device, the request for verification utilizing an application programming interface of the at least one second endpoint device;
activate user characteristic feedback hardware of the at least one second endpoint device to collect identifier data from a user of the at least one second endpoint device;
receive identifier data from the user of the at least one second endpoint device;
initiate a user characteristic data verification engine, wherein the user characteristic data verification engine receives the identifier data and determines a binary identification output; and
distribute an entirety of the electronic resources, based on the binary identification output, from an account associated with the resource vehicle owner to an account associated with the merchant.

9. The computer program product of claim 8, wherein the user characteristic data verification engine is configured to:
generate a unique signature object from the identifier data, wherein the unique signature object is configured to expire when an expiration condition is met; and
compare the unique signature object to a stored signature object.

10. The computer program product of claim 9, wherein the user characteristic data verification engine is further configured to:
continuously collect interaction data associated with the at least one second endpoint device; and
integrate the interaction data into the stored signature object.

11. The computer program product of claim 9, wherein the user characteristic data verification engine is further configured to determine the binary identification output, wherein the binary identification output is a first value when the unique signature object is not within an acceptability range of the stored signature object, and wherein the binary identification output is a second value when the unique signature object is within the acceptability range of the stored signature object.

12. The computer program product of claim 9, wherein the expiration condition is at least one selected from a group consisting of: a predetermined time interval and a signature object mismatch.

13. The computer program product of claim 9, wherein if the unique signature object expires, the user characteristic feedback hardware of the at least one second endpoint device is configured to repeat the receiving of the identifier data from the user of the at least one second endpoint device.

14. The computer program product of claim 9, wherein the stored signature object is stored in a non-transitory storage device of the at least one second endpoint device.

15. A method for electronic resource transfer authentication via a user characteristic data verification engine, the method comprising:
receiving a request to transfer electronic resources from a first endpoint device of a merchant, wherein the request is transmitted from the first endpoint device to an entity;
identifying a resource vehicle owner associated with the electronic resource transfer by comparing a resource vehicle identifier obtained by the first endpoint device with a plurality of resource vehicle identifiers in the at least one non-transitory storage device, the plurality of resource vehicle identifiers each associated with a corresponding user;
identifying at least one second endpoint device, the at least one second endpoint device associated with the resource vehicle owner;
transmitting a request for verification from the entity to the at least one second endpoint device, the request for verification utilizing an application programming interface of the at least one second endpoint device;
activating user characteristic feedback hardware of the at least one second endpoint device to collect identifier data from a user of the at least one second endpoint device;
receiving identifier data from the user of the at least one second endpoint device;
initiating a user characteristic data verification engine, wherein the user characteristic data verification engine receives the identifier data and determines a binary identification output; and
distributing an entirety of the electronic resources, based on the binary identification output, from an account associated with the resource vehicle owner to an account associated with the merchant.

16. The method of claim 15, wherein the user characteristic data verification engine is configured to:
generate a unique signature object from the identifier data, wherein the unique signature object is configured to expire when an expiration condition is met; and
compare the unique signature object to a stored signature object.

17. The method of claim 16, wherein the user characteristic data verification engine is further configured to:
continuously collect interaction data associated with the at least one second endpoint device; and
integrate the interaction data into the stored signature object.

18. The method of claim 16, wherein the user characteristic data verification engine is further configured to determine the binary identification output, wherein the binary identification output is a first value when the unique signature object is not within an acceptability range of the stored signature object, and wherein the binary identification output is a second value when the unique signature object is within the acceptability range of the stored signature object.

19. The method of claim 16, wherein the expiration condition is at least one selected from a group consisting of: a predetermined time interval and a signature object mismatch.

20. The method of claim 16, wherein if the unique signature object expires, the user characteristic feedback hardware of the at least one second endpoint device is configured to repeat the receiving of the identifier data from the user of the at least one second endpoint device.
